(19) United States
(12) Patent Application Publication
(10) Pub. No.: US 2011/0058885 A1
(43) Pub. Date: Mar. 10, 2011

(54) Variable format device for cutting print substrates and folder and printing press having a device of this kind

(75) Inventors: Theo KEILHAU, Neusaess (DE); Helmut Schnell, Augsburg (DE)

(73) Assignee: manroland AG, Offenbach am Main (DE)

(21) Appl. No.: 12/862,826

(22) Filed: Aug. 25, 2010

(30) Foreign Application Priority Data
Aug. 28, 2009 (DE) 10 2009 039 278.5

(51) Int. Cl. B41J 11/66; B26D 7/00; B65H 35/00; B65H 45/00

(52) U.S. Cl. 400/621; 83/448; 83/440; 493/357

(57) ABSTRACT

A device for cutting print substrates, i.e., paper webs, having a cutting module which comprises a cutting device, a folder, and a printing press with a device of this kind, wherein the cutting module includes guide devices having at least a partially planar and/or movable guide area for guiding the print substrate or paper web through the cutting module.

### BACKGROUND OF THE INVENTION

1. Field of the Invention

The present invention is directed to a variable format device for cutting print substrates, particularly for use in a variable format cutting and folding apparatus or configured as a variable format cutting and folding apparatus, particularly for use in a variable format printing press, particularly of a web press of this type.

2. Description of the Related Art

Web presses are well known from the prior art, for example, from standard textbooks on web offset printing. For example, web presses for commercial web printing and newspaper printing are known from Wolfgang Walenski, Der Rollenoffsetdruck, 1995, pp. 90-95, and web presses for book printing are known from pp. 98-103 of the same reference. Web presses of this type are also known from Helmut Teschner, Offsetdrucktechnik, 1997, pp. 10/25-10/28, and web presses for book printing are known from Teschner 10/76-10/82.

Further, web presses for book printing are known from DE 40 30 863 A1 which describes a web-fed rotary press having two consecutive longitudinal folding devices with two formers, where the first longitudinal folding device is arranged at a 90-degree rotation with respect to the second longitudinal folding device.

All of the above-mentioned web presses are constructed as rotary presses, i.e., in order to apply ink to a paper web, they use rotating impression cylinders in the form of plate cylinders carrying printing plates and in the form of transfer cylinders or blanket cylinders which transfer the ink from the plate cylinder to the paper web. The problem of process-related disadvantages arising from fixed cylinder circumferences has already been mentioned in Helmut Teschner, Offsetdrucktechnik, 1997, page 10/76. Nevertheless, these rotary web offset presses, i.e., web presses having rotating impression cylinders, continue in use.

Accordingly, printing mechanisms as well as folders with fixed cylinder circumferences and, therefore, fixed print sections and print formats are used in prior-art web presses, particularly in book web presses. The plate cylinders and transfer cylinders or blanket cylinders have a fixed, defined circumference. Consequently, the associated folders are also adapted to these fixed circumferences and, therefore, to fixed print formats. Therefore, as a result of the fixed circumferences of the cylinders, the print formats and printed products that can be produced always remain the same throughout the life of the web press. However, fixed formats of this kind cannot be economically and/or technologically put to optimum use for short runs (e.g., less than 1000 copies) or very short runs (e.g., less than 100 copies). Also, the production cost of printing plates and the setup time for changing printing plates in shorter runs has a much greater impact on the production costs of printed products considered as a percentage than in large runs (e.g., 1000 copies) of printed products all having the same print format. This applies similarly to newspaper printing and periodical printing with short or very short runs, especially for jobber printers who must provide constantly changing printed products on commission for many customers and publishers.

Accordingly, the demand for printing variable formats, such as in book printing and for short runs (e.g., less than 1000 copies) and very short runs (e.g., less than 100 copies down to one copy, i.e., “print on demand”), cannot be met in an economically and/or technologically optimized manner by conventional web presses.

DE 100 30 055 A1 and DE 102 13 978 A1 disclose methods and devices for cutting print substrates in which the cutting knife cylinder is accelerated to the transporting speed of the print substrate web at the moment that the cut is made. However, no guide devices or the like are provided in particular in these references.

### SUMMARY OF THE INVENTION

It is therefore an object of the present invention to provide an improved device for cutting print substrates, i.e., paper webs, and to provide a variable format folding apparatus or a variable format printing press, particularly a web press of this kind.

This and other objects and advantages are achieved in accordance with the invention by simultaneously retaining a web press and devices (including the control apparatus and folder) for roll-fed printing, i.e., printing from a rolled-up and, therefore, practically “endless” paper web such that a large variety of print formats can be printed and/or processed in an economically and/or technologically optimized manner.

A variable format printing press, particularly a web press, has printing units having printing devices or groups of printing devices for applying ink to a print substrate or paper web. There are no rotating impression cylinders in any of the printing devices or groups of printing devices. The printing units for applying ink can also be suitable for applying any other type of liquid substance to be applied to a paper web, such as varnish, liquid glue or dampening solution, and other inks such as toner-based inks, or the like. Since rotating impression cylinders can be dispensed with, the device can be freed from the constraint of fixed cylinder circumferences which always limit print formats to a fraction of the cylinder circumference, such as 1, ½, ⅓ or ¼. The print substrate and, in particular, the paper web arranged on a roll does not have this limitation because it is practically “endless”—limited only by the width of the print substrate or paper web—and permits printing of any format sizes. Accordingly, by dispensing with rotating impression cylinders, a variable format printing press, i.e., a variable format web press, is made possible which can print a large range of print formats. The print formats of a printed image or printed page on the print substrate or paper web can differ particularly in length (dimension in the running direction of the print substrate or paper web) and/or width (dimension in the direction transverse to the paper web), but also in alignment (distance of the printed image from the edge of the paper web, distances between the printed images, angles between the longitudinal edge of the printed image and running direction of the print substrate or paper web).

The printing devices or groups of printing devices can be configured to apply ink to the print substrate or paper web without contacting. In particular, they can be constructed as devices for applying ink in drops or spray by a drop dispensing device or nozzle device, such as an inkjet device. In this way, direct contact between the print substrate or paper web and the printing devices is avoided, and it is possible for ink to be applied to the print substrate or paper web in different formats. The printing devices or groups of printing devices can also be configured for contactless application of toner-based ink to the print substrate or paper web.

Further, a control device can be provided for controlling and/or regulating the printing devices or groups of printing devices and for controlling and/or regulating an actuating device of at least one cutting device for cutting at least a portion of the print substrate or paper web, where the control of the actuating device is performed depending on print format settings for the printing devices or groups of printing devices. This construction of the control device in combination with an object of the invention—and possibly with its further embodiments as described herein—yields an especially favorable synergy, particularly for a variable format printing process. It is ensured that the entire printing and processing process is adapted in an optimal manner and in conformity to the respective print format precisely in that the knowledge of the print format settings for the printing devices or groups of printing devices is used for controlling an actuating device of at least one cutting device in a control device, particularly a shared control device.

Within the meaning of the invention, the control of a device when referred to in the description of the invention may always also comprehend regulation of this device. Conversely, within the meaning of the invention, regulation of a device when referred to in the description of the invention may always also comprehend control of this device.

In the following, frequent reference is also made to the running direction L of the print substrate or paper web. Within the meaning of the invention, the running direction of the print substrate or paper web is not defined as a universal fixed plane in space because the print substrate or paper web executes several changes in direction and possibly also loops as is clearly indicated in the drawings. However, the skilled person will be able to determine a clear spatial direction from the local running direction of the paper web in each particular instance, i.e., for every section of the print substrate or paper web.

In an embodiment, the control device is configured to control and/or regulate a motorized actuating device of a cutting device with cutting knives. Here, the motorized actuating device can comprise a drive motor or servomotor, for example.

In another embodiment, the control device is configured to control and/or regulate the actuating device subject to pre-stored or pre-calculated control curves. These control curves can define a spatial and/or temporal curve for the operating state of the actuating device, i.e., the operating state or operating parameters (such as pressure, intensity, force, speed, spatial position or clock frequency) of the actuating device can be changed spatially or temporally by these control curves.

In another embodiment, the cutting device is configured as a rotating cutting device, and the control device for controlling and/or regulating the actuating device can be constructed such that the cutting device can be operated at varying angular velocity per revolution.

In further embodiments, the angular velocity (or tangential component of the rotational velocity in the running direction of the print substrate or paper web) of the cutting knife when contacting the print substrate or paper, web is equal to the transporting speed of the print substrate or paper web. Accordingly, the rotational velocity is adapted per revolution of the rotating cutting device such that the cutting knife and the paper web have the same velocity at least during contact with one another, so that there is no relative velocity between the two at the point of contact. This prevents a tearing or picking of the print substrate or paper web.

In yet another embodiment, the printing devices or groups of printing devices have a nozzle device, such as an inkjet device, for spraying ink on a print substrate or a paper web, or the printing devices or groups of printing devices have a toner device for applying toner-based ink to a print substrate or a paper web.

In an embodiment, printing devices or groups of printing devices or web guiding elements for guiding the print substrate or paper web, which are adjacent to the printing devices, are mounted so as to be displaceable perpendicular to the web plane. This can be used in particular for the relative alignment of the printing devices or groups of printing devices or web guiding elements relative to one another and/or relative to the print substrate or paper web.

Printing devices or groups of printing devices or web guiding elements for guiding the print substrate or paper web which are adjacent to the printing devices can be controlled or regulated by a control device so as to be displaceable perpendicular to the web plane such that a predefined distance is maintained between the print substrate or paper web and the printing devices. This may be required particularly in printing devices having a nozzle device.

In further embodiments, a plurality of printing devices or groups of printing devices is so that the printing devices or groups of printing devices are arranged one behind the other in the running direction of the print substrate or paper web. This can be used, for example, for printing a plurality of inks successively.

The individual printing devices of a group of printing devices can also be constructed, respectively, for applying different inks. Accordingly, while printing devices can print upon the print substrate or paper web with only one ink in principle, printing devices may also be provided for printing different inks, and certain printing devices for printing different inks are assembled to form a group. These groups are characterized, for example, by a similar spatial arrangement or in that they are controlled in common.

In still further embodiments, at least one dryer is provided downstream of at least one of the printing units in the running direction of the print substrate or paper web. In particular, heatset production is thus made possible.

In another embodiment, the dryer is structurally integrated in a printing unit. A particularly compact structural or spatial arrangement of the printing unit and dryer is thus provided.

In a further embodiment, the dryer is structurally or spatially integrated in a printing unit such that dryer operation is prevented from influencing the printing devices. This takes into account the fact that disruptive influences, such as heat radiation, vibrations or electromagnetic fields, can emanate from the dryer and influence the functioning of the printing devices. The contemplated embodiment prevents a disruptive influence of the dryer operation upon the printing devices, such as by suitable spatial separation or distances, suitable relative spatial arrangement of the dryer and printing devices with respect to one another or by suitable shielding.

In principle, the dryer can be arranged below the printing devices, for example. Here, however, depending upon the type and construction of the dryer, there may be a risk of a rise in generated heat and an unwanted heating of the printing devices. Therefore, in another embodiment the dryer is arranged spatially above the printing devices of a printing unit.

In yet another embodiment, a folder is arranged downstream of the printing units and has a plurality of folding devices arranged in series or arranged in parallel with one another in the running direction of the print substrate or paper web. This arrangement of the folder in combination with an object of the invention—and, as the case may be, with its further embodiments as described so far—results in an especially favorable synergy, particularly for a variable format printing process. The two folding devices provide extensive freedom for the design and processing of printed products precisely for variable format printing processes.

In another embodiment, the arrangement of the folding devices and the guiding of the print substrate or paper web in the folder are effected such that the fold lines already mentioned above each define the fold of the print substrate or paper web by one of the folding devices. In this way, in particular, areas of the print substrate or paper web which are not imprinted or which are overprinted can be accurately aligned such that they lie on a fold of the printed products and, therefore, are not disagreeably noticeable in the finished printed product.

In another embodiment, a folding device, or each folding device, is displaceable in at least one spatial direction, where the first folding device is displaceable in a first spatial direction and the second folding device is displaceable in a spatial direction perpendicular thereto. In contrast, DE 40 30 863 A1 provides for a displacement of only one of two formers, where the other former is fixed. Accordingly, the present embodiment offers an improved freedom in the orientation and adaptation of the folding devices to a wide variety of print formats, widths and guides of the print substrate and to paper web widths and paper web guides. In particular, this ensures that the post-processing equipment (such as cutting devices, web or sheet guides, or grippers) arranged downstream in the running direction of the print substrate or paper web requires little or no adjustment (e.g., spatial displacement) to changed print formats, widths and guides of the print substrate or to changed paper web widths or paper web guides. Rather, such adjustment can be implemented by displacement of the folding devices.

In even a further embodiment, the at least one folding device is additionally also displaceable in the second spatial direction or in a third spatial direction perpendicular to the first spatial direction. This adjustability of the one folding device further facilitates adaptation with respect to the alignment and adaptation of the folding devices to a wide variety of print formats, widths and guiding of the print substrate or of paper web widths or paper web guidance. For example, a symmetric or asymmetric guiding of the print substrate or paper web through the printing devices can also be compensated because of the capability of displacement along two axes and the possibility of varying the web widths and print formats. This ensures that the post-processing equipment (cutting devices, web or sheet guides, grippers, etc.) arranged downstream in the running direction of the print substrate or paper web requires little or no adjustment (e.g., spatial displacement) to changed print formats, width and guiding of the print substrate or of paper web widths or paper web guides.

In a still further embodiment, the folder has a sheet transporting element or paper sheet transporting element with a drive, and the drive is regulated by the control device or by a separate control device such that sheets or paper sheets which are severed from the print substrate or paper web by the cutting device are accelerated away from the rest of the print substrate or from the rest of the paper web in the running direction of the print substrate or paper web. In this way, in particular, paper sheets which are severed from the print substrate or paper web are spatially separated by a defined distance from the rest of the print substrate or from the rest of the paper web, or from subsequently severed paper sheets, downstream of the cutting device. Therefore, these sheets or paper sheets can be separately acquired and/or processed more easily in post-processing equipment.

In an even further embodiment, a device with a drive is arranged downstream of the sheet or paper sheet transporting element, and the drive is regulated by the control device or by a separate control device in such a way that the transporting movement of the previously accelerated sheets or paper sheets is slowed down. In this way, in particular, separated sheets or paper sheets can be gathered, e.g., in order to generate products in multiple layers.

In another embodiment, the above-mentioned device is constructed such that at least a portion of the sheets or paper sheets, in addition to being slowed down, is lifted or lowered for shingling the sheets or paper sheets. Lifting or lowering at least a portion of the sheets or paper sheets in this way, for example, the front edge or rear edge (considered in the running direction of the print substrate or paper web), facilitates shingling of the sheets or paper sheets because succeeding sheets or paper sheets are then guided over or under the preceding sheets or paper sheets.

In an embodiment, a web turner device which is arranged downstream of the printing units and which has a plurality of longitudinal cutters for dividing the print substrate or paper web into web sections, and post-processing equipment without a former which has a cutting module for severing sheets or paper sheets from the rest of the print substrate or from the rest of the paper web and a delivery module for gathering and/or delivering and/or shingling the sheets or paper sheets.

Accordingly, formers—and possibly also other folding devices—can be omitted in this embodiment because the required product width is already achieved by cutting the print substrate or paper web into web sections and the required product length is produced by the cutting module for severing sheets and paper sheets. In the adjoining delivery module, the sheets or paper sheets generated in this way can be gathered to form products, shingled and/or delivered. This affords a possibility for a very simple cooperation between the printing units described above and a web turner device and post-processing equipment.

A variable format printing press can be provided, in particular a variable format web press such as a book printing web press, a variable format newspaper printing web press, or a variable format commercial web press, which can be constructed or further developed particularly according to one or more of the technical features described above and which has printing devices such as inkjet printing devices or toner printing devices or groups of inkjet printing devices or toner printing devices and a control device for controlling and/or regulating the printing devices or groups of printing devices and for controlling and/or regulating an actuating device of at least one cutting device, wherein the control of the actuating device is performed as a function of print format settings for the printing devices or groups of printing devices.

Inkjet printing devices or toner printing devices are printing devices which do not have rotating impression cylinders and are at the same time printing devices or groups of printing devices for applying ink to the print substrate or the paper web in a noncontacting manner. The present embodiment of the control device for controlling printing devices or groups of printing devices and for controlling an actuating device of at least one cutting device results in an especially favorable synergy particularly for a variable format printing process. Here, it is ensured that the entire printing and processing process is adapted in an optimal manner and in conformity to the print format precisely in that the knowledge of the print format settings for the printing devices or groups of printing devices is used for controlling an actuating device of at least one cutting device in a control device, particularly a shared control device. Within the meaning of the contemplated embodiments, variable format web presses means that the print format settings of printed pages and/or of printed images on the print substrate or paper web—particularly with respect to length (dimension in the running direction of the print substrate or paper web) and/or width (dimension in direction transverse to the print substrate or paper web) and/or alignment (distance of the printed image from the edge of the print substrate or paper web, distances between the printed images, angles between the longitudinal edge of the printed image and the running direction of the print substrate or paper web)—can be varied extensively, limited substantially only by the width of the print substrate or paper web employed.

In another embodiment, a folder is provided, particularly for use with a web press and/or a control device according to one or more of the technical features described above. In another embodiment of the invention, an actuating device of a rotating cutting device is controlled by a control device such that the cutting device is operated at varying angular velocity per revolution. It can also be provided that the angular velocity during contact between a cutting knife and the print substrate or paper web is equal to the transporting speed of the print substrate or paper web. Accordingly, the rotational velocity is adjusted per revolution of the rotating cutting device such that the cutting knife and the paper web have the same velocity at least during contact between the cutting knife and paper web, so that there is no relative velocity between them at the point of contact. As a result, tearing or picking is prevented from occurring.

In another embodiment, a device for cutting paper webs is provided with a cutting module having a cutting device, where this cutting module comprises guide devices which have at least a partially planar and/or movable guide area for guiding the paper web through the cutting module.

In another embodiment, a device for cutting print substrates is provided with a cutting module having a cutting device, where this cutting module comprises guide devices which have at least a partially planar and/or movable guide area for guiding the print substrate through the cutting module.

In a previously contemplated device mentioned above, a guide device comprises a cutting element of a cutting device. Alternatively and/or in addition, in another embodiment at least one guide device has guide elements which are movable with a print substrate, particularly with a paper web. Accordingly, the guide elements can be constructed such that the guide elements move along with a print substrate or with a paper web at least in the guide area in the running direction of the print substrate or the paper web, particularly at the same speed at which the print substrate or the paper web moves in the running direction of the print substrate or paper web. This speed can also be determined by the movement of the guide elements in the guide areas, for example, by actively driven guide elements. Alternatively and/or in addition, in another embodiment the cutting element for cutting the print substrate, particularly for cutting a paper web, is arranged only in those sections of a print substrate or paper web in which a guide device has no contact with the print substrate or a paper web. In this way, a cut or partial cut is thus made by the cutting element only in those areas of a print substrate or paper web in which a guide device has no contact with the print substrate or a paper web. In this way, for example, a perforation of a print substrate or a paper web can be produced, or a first partial cut of a print substrate or a paper web can be made which is later expanded or supplemented to make a complete cut (severing cut) in a print substrate or a paper web.

In even a further embodiment, at least one guide device is constructed as a belt conveyor. Alternatively and/or in addition, a plurality of cutting elements arranged one behind the is provided in the running direction of the print substrate, particularly of a paper web, which are configured to cut a print substrate or a paper web in sections of a print substrate, particularly of a paper web, which are offset relative to one another transverse to the running direction of the print substrate or a paper web. In so doing, each of the cutting elements can be configured such that it produces a cut or partial cut only in those areas of a print substrate, particularly of a paper web, in which a guide device has no contact with the print substrate or a paper web. In this way, for example, a perforation of a print substrate or of a paper web can be produced by each of the cutting elements, or a first partial cut in a print substrate or a paper web can be produced by a first cutting element and subsequently expanded or supplemented to form a complete cut in a print substrate or a paper web by means of a second cutting element or additional cutting elements. In so doing, the cutting elements in their entirety need not be offset relative to one another. Rather, it is sufficient when the elements of the cutting elements required for the cut, e.g., blades or blade portions of a blade that is discontinuous transverse to the running direction, are offset relative to one another.

Accordingly, the contemplated embodiments of the invention permit a variably shaped cut accompanied by improved guiding of the print substrate, particularly of a paper web.

In still a further embodiment, a folder is provided with a device of the kind mentioned above, which folder has a plurality of folding devices that are arranged in series or in parallel with one another in the running direction of a print substrate, particularly a paper web. This folder can be constructed according to one or more of the features described in the present document.

In other embodiments, every folding device is displaceable in at least one spatial direction, where the first folding device is displaceable in a first spatial direction and the second folding device is displaceable in a spatial direction perpendicular thereto. Alternatively and/or in addition, an embodiment is provided in which at least one folding device is additionally also displaceable in the second spatial direction or in a third spatial direction perpendicular to the first spatial direction.

In a further embodiment, a variable format printing press, in particular a web press, is provided with a device comprising one or more of the technical features mentioned above. In particular, a control device for controlling and/or regulating the printing devices and for controlling and/or regulating an actuating device of at least one cutting device for cutting at least a portion of a print substrate, particularly a paper web, is provided, where the control and/or regulation of the actuating device is performed as a function of print format settings for the printing devices.

In another embodiment, the control device is configured for controlling and/or regulating a motorized actuating device of a cutting device with cutting elements, particularly with cutting knives.

In further embodiments, the control device is configured to control and/or regulate the actuating device subject to pre-stored or pre-calculated control curves.

In yet another embodiment, the cutting device also includes rotating cutting elements and the control device for controlling and/or regulating the actuating device is constructed such that the cutting device can be operated at varying angular velocity per revolution, particularly such that the angular velocity is equal to the transporting speed of a print substrate, i.e., a paper web, when a cutting knife makes contact with the paper web.

Other materials suitable for imprinting as paper or paper webs, e.g., paper sheets, transparencies, cardboard, or sheet metal, are also conceivable as print substrates.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Specific embodiment examples of the present invention are shown in the following with reference to the drawings, in which:

FIG. 1 is an illustration of a variable format web press;

FIG. 2 is an illustration of a variable format web press with control;

FIG. 3 is a graphical plot of control curves;

FIG. 4 is an illustration of printing units for contactless printing, particularly with inkjet printing devices;

FIG. 5 is an illustration of folder (a) in a side view and (b) in a top view;

FIG. 6 is an illustration of an alternative construction of a folder corresponding to FIGS. 1 and 2;

FIGS. 7a and 7b is an illustration of a detail of a cutting module according to FIGS. 1,2 and 6;

FIG. 8 is an illustration of an arrangement of two displaceable formers;

FIG. 9 is an illustration of fold lines and web guidance on a former with printing devices extending over part of the width of the paper web;

FIG. 10 is an illustration of alternative fold lines and web guidance on two formers with printing devices extending over part of the width of the paper web;

FIG. 11 is an illustration of fold lines and web guidance on two formers with alternative printing devices extending over part of the width of the paper web;

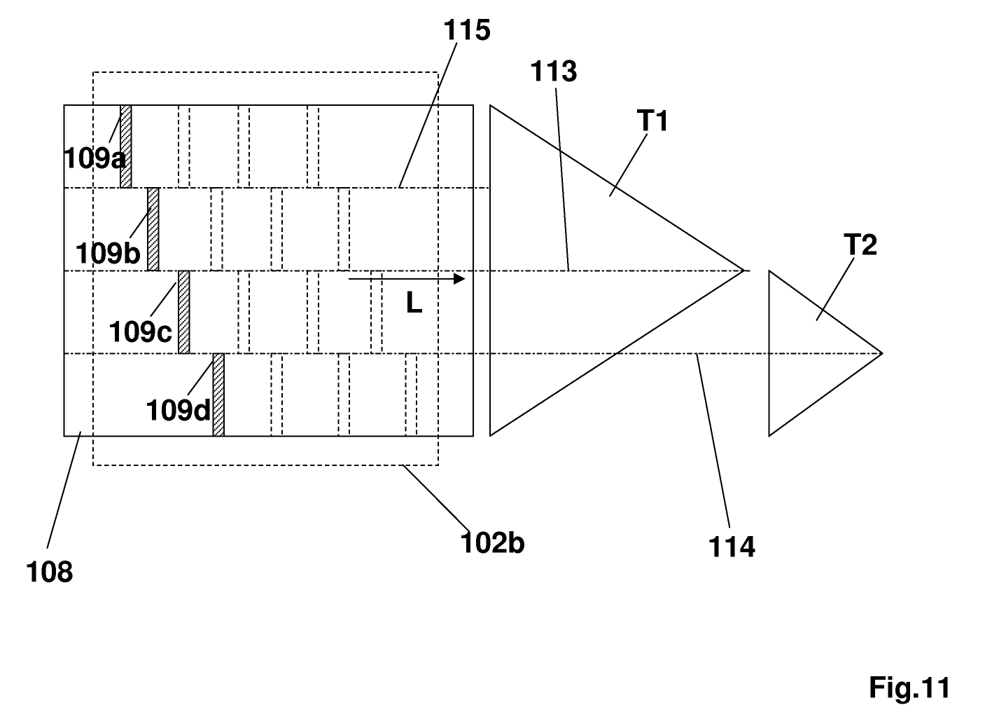

FIG. 12 is an illustration of a schematic view of a embodiment for processing a paper web in the folder according to the preceding drawings;

FIG. 13 is an illustration of a schematic view of an alternative embodiment for processing a paper web in the folder according to the preceding drawings;

FIG. 14 is an illustration of post-processing equipment with cutting module and delivery module;

FIG. 15 is an illustration of a top view of post-processing equipment with cutting module and delivery module according to the preceding drawings;

FIG. 16 is an illustration of a schematic view of a possibility for processing a paper web with a web turner device; and

FIG. 17 is an illustration of a shingling of paper sheets to form products comprising multiple layers.

### DETAILED DESCRIPTION OF THE PREFERRED EMBODIMENTS

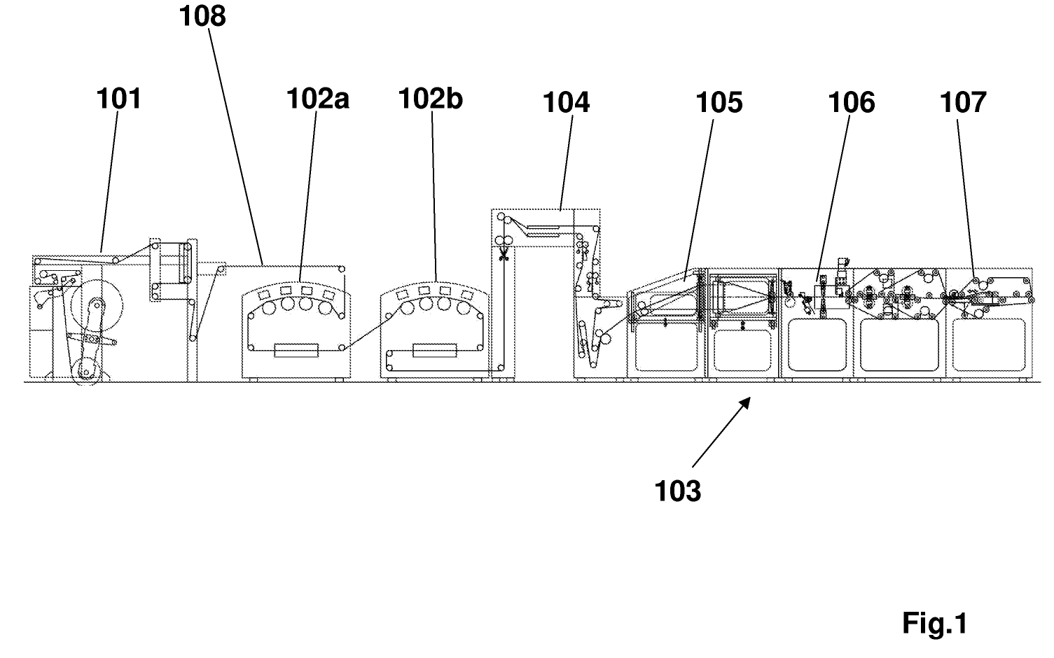

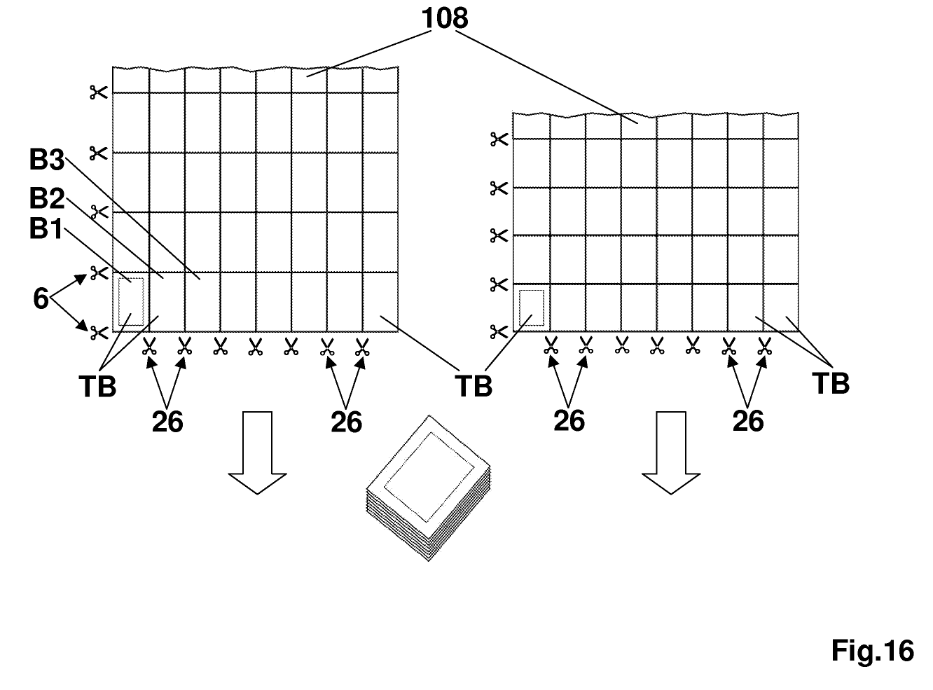

FIG. 1 shows a variable format printing press formed as a variable format web press, particularly a variable format heatset web press, such as for book printing or commercial web printing. This web press has a reel changer 101 from which a paper web 108 serving as print substrate is taken off and guided through printing units 102a, 102b. Subsequently, the paper web is guided to a folder 103 which includes the following: a web turner device 104, for example, in the form of a turner bar device, a folding module 105, a cutting module 106, and a delivery module 107. In certain embodiments, the folding module 105 can also be omitted or can at least be circumvented as will be described in more detail in the following referring to FIG. 16.

As can be seen from the diagrams in FIGS. 1, 2, 6, 7a and 7b, these drawings show a device 103 for cutting paper webs 108 having a cutting module 106 comprising a cutting device 6 or cutting devices 6. The cutting module 106 has guide devices 206, 208 which have at least partially planar guide areas F1, F2 for guiding the paper web 108 through the cutting module 106 and/or movable guide areas F1, F2 which have guide elements which are movable along with a paper web 108 and which are constructed in such that they move together with a paper web at least in the guide area the running direction of the print substrate or paper web.

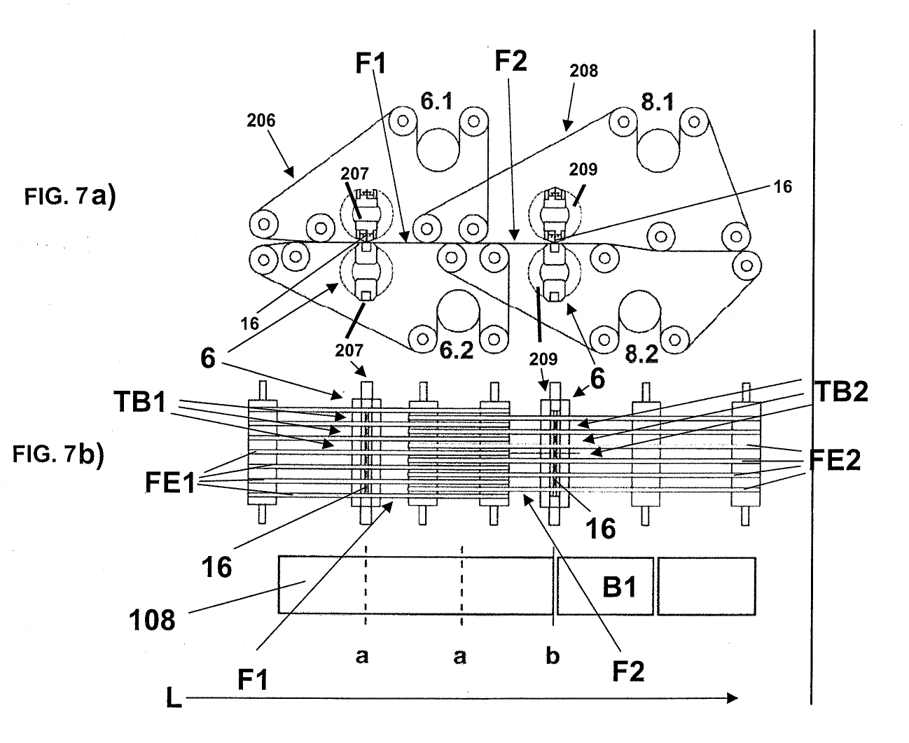

In this connection, as is shown in the diagrams of FIGS. 1, 2, 6, 7a and 7b, a guide device 206, 208 is provided which comprises a cutting element 207, 209 of a cutting device 6. The cutting element 207, 209 can be configured to cut a paper web 108 only in those sections TB1, TB2 of a paper web 108 in which a guide device 206, 208 does not have contact with a paper web 108. These sections TB1, TB2 are shown particularly in FIG. 7b).

As can be seen from the diagrams of FIGS. 1, 2, 6, 7a and 7b, these drawings show that the guide devices 206, 208 are constructed as a belt conveyor. Further, a plurality of cutting elements 207, 209 can be provided which are arranged one behind the other in the running direction L of a paper web 108 and which are configured to cut a paper web 108 in sections TB1, TB2 of a paper web 108 that are offset relative to one another transverse to the running direction L of a paper web 108. In this connection, each of the cutting elements 207, 209 is configured such a way that it produces a cut or partial cut only in those areas of a paper web 108 in which a guide device 206, 208 has no contact with the print substrate, particularly a paper web. In this way, for example, a perforation of a paper web can be produced by each of the cutting elements 207, 209, or a first partial cut a can be produced in a paper web (see FIG. 7b) by a first cutting element 207 and subsequently expanded or supplemented to form a complete cut b in a paper web with a second cutting element 209 or additional cutting elements. In so doing, the cutting elements 207, 209 in their entirety need not be offset relative to one another. It is sufficient when the elements of the cutting elements 207, 209 required for the cut, such as blades or partial cutting knives 16 or blade portions or cutting knife portions of a cutting knife 16 that is discontinuous transverse to the running direction L of a paper web 108, are offset relative to one another. The cutting knife 16 can have as many partial cutting knives as there are sections TB1, TB2 transverse to the running direction L of a paper web 108.

The guide device 206, 208 has movable guide areas F1, F2 which are formed such that the guide device 206, 208 has movable guide elements FE1, FE2 which are movable together with a print substrate, particularly with a paper web 108. Accordingly, the guide elements FE1, FE2 can be constructed such that they move along with a paper web 108 at least in the guide area F1, F2 in the running direction L of the paper web 108, particularly at the same speed at which the paper web 108 moves in the running direction L of the paper web. This speed can also be determined by the movement of the guide elements FE1, FE2 in the guide areas F1, F2, for example, by actively driven guide elements FE1, FE2. FIGS. 7a and 7b shows that the guide elements FE1, FE2 can be constructed as belts.

Accordingly, the endless paper web 108 runs in running direction L in a first guide device 206 which is constructed as a belt conveyor. This first guide device 206 is guided around a first cutting mechanism 6 with first cutting elements 207 in the form of cutting cylinders. The speed of the guide elements FE1, FE2 constructed as belts in the guide areas F1, F2 in running direction L is identical to, or almost identical to, the speed of the paper web 108 in running direction L in the guide areas F1, F2. The first cutting elements 207 in the form of cutting cylinders perform a first discontinuous cut in sections TB1 between the individual guide elements FE1 constructed as belts. For this purpose, the cutting knife 16 of the first cutting elements 207 has blade portions or a discontinuous blade which is arranged and formed such that a partial cut is only made in sections TB1. In accordance with the invention, a synchronous or almost synchronous speed is provided between the cutting knife 16 of the first cutting elements 207 and the paper web 108 only during the cutting process as will be described in the following for the corresponding angular velocities. It should be noted that during the remaining time, the cutting knife 16 of the first cutting elements 207 can lead or lag behind the paper web or the speed of the paper web in running direction L. During the lead phase or lag phase, there is no contact between the cutting knife 16 of the first cutting elements 207 and the paper web 108.

Subsequently, the paper web 108, which is now provided with a partial cut a or a perforation a only in sections TB1, exits the first guide device 206 and is transferred to the second guide device 208. This second guide device 208 is guided around a second cutting device 6 with two cutting elements 209 in the form of cutting cylinders. The movable guide elements FE1 of the first guide device 206 which are constructed in particular as belts—although this is not compulsory—mesh with the movable guide elements FE2 of the second guide device 208 which are constructed in particular as belts—although this is not compulsory—as is shown in FIG. 7b. Accordingly, the paper web 108 is permanently guided through the guide device 206, 208, particularly through the guide elements FE1, FE2 in running direction L of the paper web 108.

Further, because of the meshing arrangement of the guide elements FE2 of the second guide device 208 relative to the guide elements FE1 of the first guide device 206, the sections TB2 of the paper web 108 which are not yet severed can be accessed for another cutting process for the second cutting device 6 with the second cutting elements 209. For this purpose, the cutting knife 16 of the second cutting elements 209 has blade portions or a discontinuous blade which is arranged and formed such that another partial cut is only made in sections TB2. The two partial cuts of the cutting knives 16 of the first and second cutting elements 207, 209 together produce a complete severing cut b which severs a sheet B1 from the paper web 108.

The speed of the guide elements FE2 constructed as belts in the guide areas F2 in running direction L is identical or almost identical to the speed of the paper web 108 in running direction L in the guide areas F2 but can also be slightly greater than the speed of the paper web 108 in running direction L in guide areas F2. In an embodiment, a synchronous or almost synchronous speed is provided between the cutting knife 16 of the second cutting elements 209 and the paper web 108 only during the cutting process as will be described in the following for the corresponding angular velocities. At other times, the cutting knife 16 of the second cutting elements 209 can lead or lag behind the paper web or the speed of the paper web in running direction L. During the lead phase or lag phase, there is no contact between the cutting knife 16 of the second cutting elements 209 and the paper web 108.

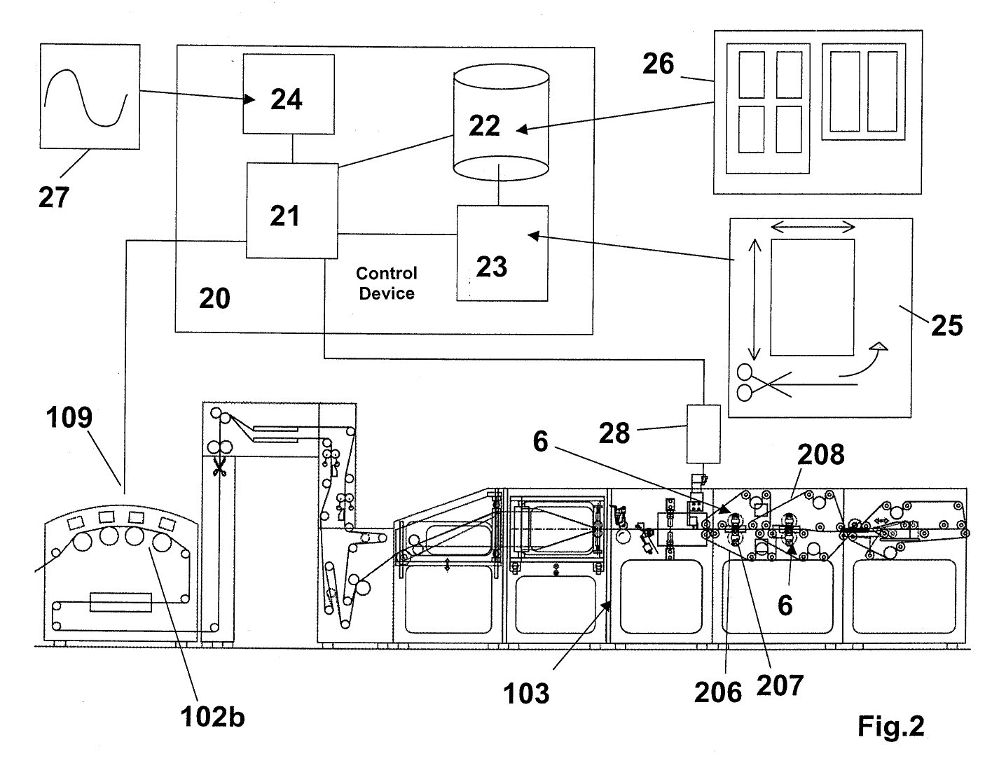

The first and second cutting elements 207, 209 as well as the guide device 206, 208 and the movable guide elements FE1, FE2 can each be driven by their own motor 28 (see FIG. 2) and/or can be driven by their own variators and/or some or all of the first and second cutting elements 207, 209 and the guide device 206, 208 can be driven by a common motor 28 and/or common variators.

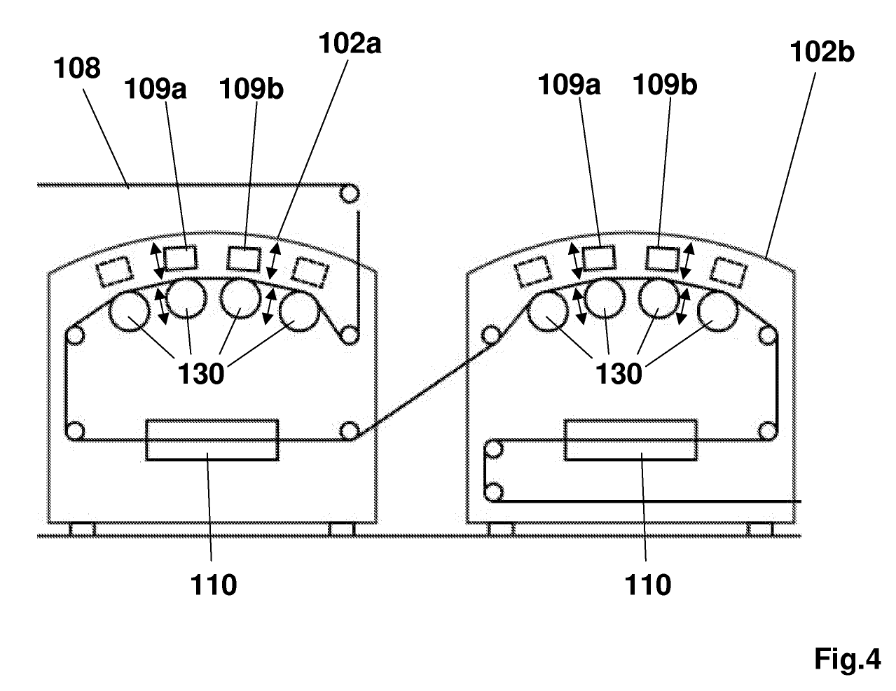

FIG. 4 shows that the printing units 102a, 102b have printing devices 109, 109a, 109b, none of which has rotating impression cylinders. The printing devices 109, 109a, 109b are configured for contactless application of ink to the paper web 108.

The printing devices 109, 109a, 109b are constructed in the exemplary embodiments described herein as inkjet printing devices 109, 109a, 109b or, for example, as toner-based printing devices 109, 109a, 109b or other printing devices 109, 109a, 109b which make do without fixed printing plates.

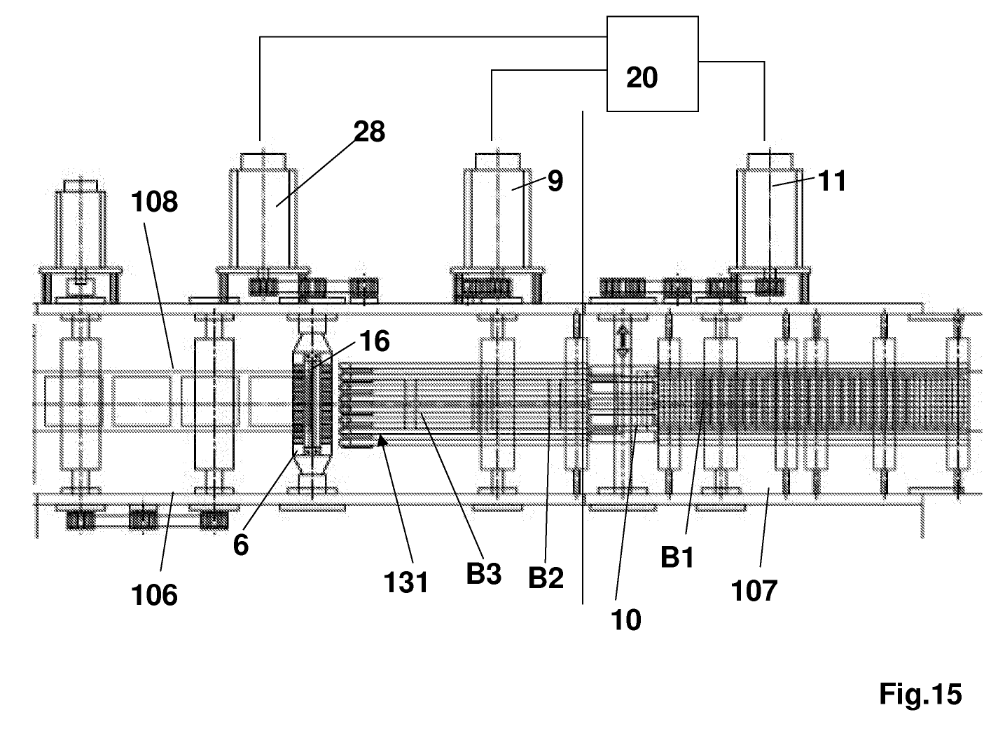

FIGS. 2, 6 and 7 again show the web press according to FIG. 1 with an associated control device 20. On one hand, the control device 20 is provided for controlling and/or regulating the printing devices 109, 109a, 109b. At the same time, the control device 20 is also provided at least for controlling and/or regulating an actuating device 28 of at least one cutting device 6 for cutting at least a portion of the paper web 108. Here, the actuating device 28 is provided with a motor. According to FIGS. 2, 6, 7 and 15, the cutting device 6 is constructed as a cutting knife cylinder 207, 209 with cutting knives 16 which rotates during the operation of the web press and accordingly brings the cutting knives 16 into regular contact with the paper web 108. According to FIG. 2 and FIG. 15, the motorized actuating device 28 is constructed as a drive motor.

The control and/or regulation of the actuating device 28 is performed subject to print format settings 25, 26 for the printing devices 109, 109a, 109b. The control device 20 is constructed for controlling and/or regulating the motorized actuating device 28 as a function of pre-stored or pre-calculated control curves 27.

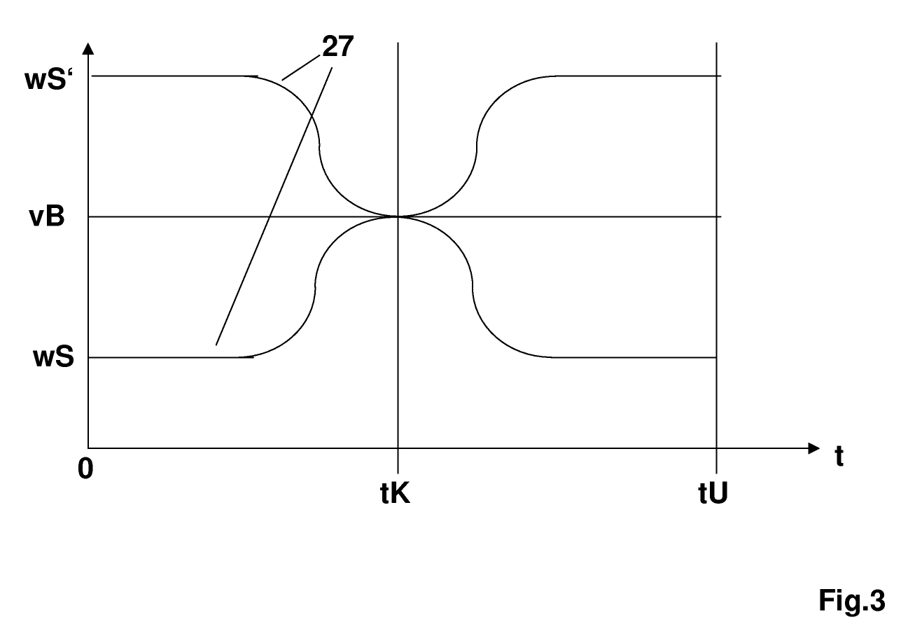

To this end, the control device 20 has a computing device or a data device 24 constructed as a data storage in which control curves 27 are stored or calculated. FIG. 3 is a graphical plot of exemplary control curves . These control curves depicted in FIG. 3 show the temporal curve of the angular velocity wS, wS′ of the cutting knife 16 of the cutting device 6. The motorized actuating device 28, i.e., the drive motor, of the cutting device 6 is controlled or regulated in such a way that the cutting device 6 and, therefore, also every cutting knife 16 moves at varying angular velocity wS, wS′ per revolution tU, i.e., during the time span from t=0 to t=tU needed by the cutting cylinder to complete a revolution of 360°. The angular velocity wS, wS′ varies according to FIG. 3 such that when a cutting knife 16 contacts the paper web at time tK, the angular velocity wS, wS′ of the cutting device 6 and, therefore, of every cutting knife 16 or, more precisely, the tangential component of the rotational velocity of the contacting cutting knife 16 in the running direction of the paper web at time tK, is equal to the transporting speed vB of the paper web 108, i.e., equal to the speed vB at which the paper web 108 moves through the printing machine. Accordingly, the rotational velocity is adapted per revolution of the rotating cutting device such that at least when there is contact between the cutting knife 16 and the paper web 108, this cutting knife 16 and paper web 108 have the same speed so that there is no relative velocity between the two at the point of contact. If the angular velocity wS of the cutting device 6 and, therefore, also of every cutting knife 16 or, more precisely, the tangential component of the rotational velocity of the contacting cutting knife 16 in the running direction of the paper web 108, is less than the transporting speed vB of the paper web 108, the cutting knife 16 is accelerated to transporting speed vB at the time tK of contact between the cutting knife 16 and the paper web 108. If the angular velocity wS′ of the cutting device 6 and, therefore, also of every cutting knife 16 or, more precisely, the tangential component of the rotational velocity of the contacting cutting knife 16 in the running direction of the paper web 108, is greater than the transporting speed vB of the paper web 108, the cutting knife 16 is slowed down to transporting speed vB at the time tK of contact between the cutting knife 16 and the paper web 108. As a result, tearing or picking of the paper web 108 is prevented from occurring.

In addition, the control device 20 includes a controlling and/or regulating module 21 having a data link to the data device 24 and to the printing devices 109, 109a, 109b and the motorized actuating device 28, i.e., the drive motor, of the cutting device 6.

Further, FIG. 2 shows that the control device 20 has, or at least can have, another data storage 22 in which print format settings 26 are stored and which has a data link to the controlling and/or regulating module 21. These print format settings 26 can be stored, e.g., in the form of pre-stored data relating to printed image formats or printed page formats, particularly as data relating to the length (dimension in the running direction of the paper web 108) and/or width (dimension in direction transverse to the paper web 108) and alignment (distance of the printed image from the edge of the paper web 108, distances between the printed images, angles between the longitudinal edge of the printed image and the running direction L of the paper web 108).

FIG. 2 additionally shows that the control device has, or at least can have, a data processing device 23 in which print format settings 25 can be calculated and/or processed, particularly as data relating to the length (dimension in the running direction of the paper web 108) and/or width (dimension in direction transverse to the paper web 108) and alignment (distance of the printed image from the edge of the paper web 108, distances between the printed images, angles between the longitudinal edge of the printed image and the running direction L of the paper web 108). For example, pre-stored data relating to printed image formats or printed page formats which are stored in the data storage 22 can be read out, modified and/or processed by the data processing device 23, and/or new or modified data relating to printed image formats or printed page formats can also be entered by the data processing device 23 over other interfaces and transmitted to the controlling and/or regulating module 21 of the control device 20 by data link.

FIG. 4 shows an example of the internal construction of the printing units 102a, 102b. The paper web 108 is guided successively through the printing units 102a, 102b, for example, by suitable guide rollers or other web guiding elements. The paper web 108 is guided in the printing units 102a, 102b by web guiding elements 130, such as, support rollers, which are adjacent to the printing devices 109a, 109b. According to FIG. 4, these web guiding elements 130 or support rollers are located across from the printing devices 109a, 109b on the other side of the paper web 108. The web guiding elements 130 or support rollers serve to guide the paper web 108 and cause a predefined distance to be maintained between the paper web 108 and the printing devices 109a, 109b. This distance can be fixed in principle, but can also be controlled or regulated by a control device such as the control device 20, e.g., in that the printing devices 109a, 109b or web guiding elements 130 are displaceable perpendicular to the plane of the paper web 108 as is indicated by the double-arrow in FIG. 4.

FIG. 4 further shows at least one dryer 110 arranged downstream of each of the printing units 102a, 102b in the running direction L of the paper web 108. Within the meaning of the disclosed embodiments of the invention, the running direction L of the paper web is not defined as a universal fixed plane in space because the paper web 108 executes several changes in direction and possibly also loops as is clearly indicated in FIG. 1. However, the person skilled in the art will be able to determine a clear spatial direction from the local running direction L of the paper web 108 in each particular instance, i.e., for every section of the paper web 108.

FIG. 4 shows a construction in which each dryer 110 is structurally integrated in a printing unit 102a, 102b. Each dryer 110 can be structurally or spatially integrated in a printing unit 102a, 102b such that the dryer operation is prevented from influencing the printing devices 109a, 109b. Accordingly, each dryer 110 can be arranged spatially above the printing devices 109a, 109b of the respective printing unit 102a, 102b. This prevents the risk of an increase in generated heat and an unwanted heating of the printing devices 109a, 109b. However, the dryer 110 can also be arranged below the printing devices 109a, 109b of the respective printing unit 102a, 102b when the dryer 110 and printing unit 102a, 102b are suitably designed.

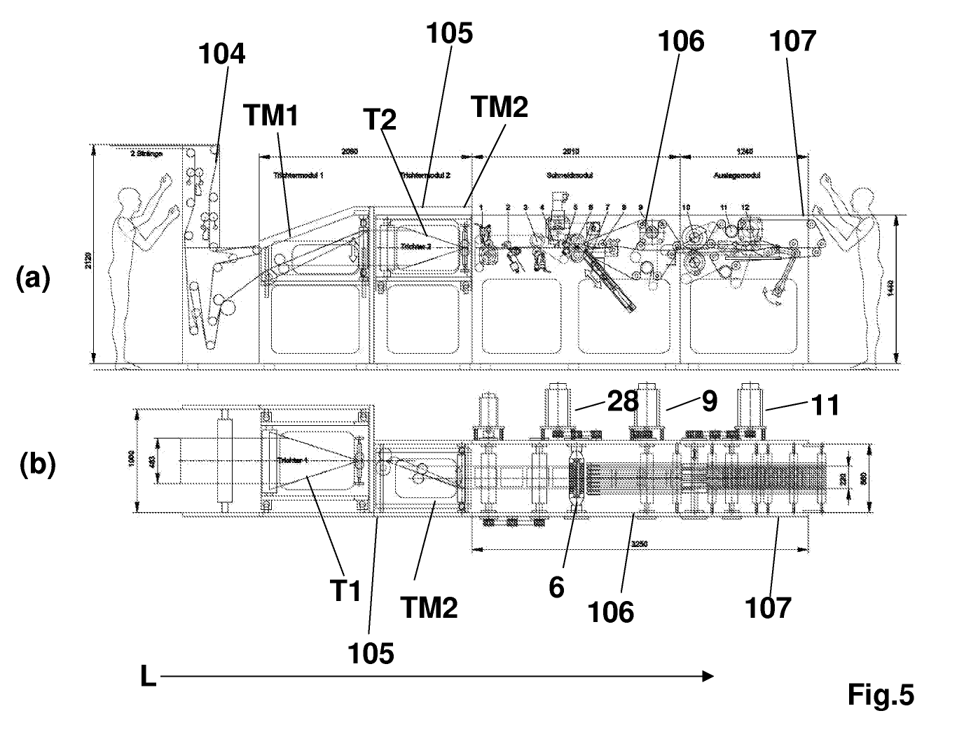

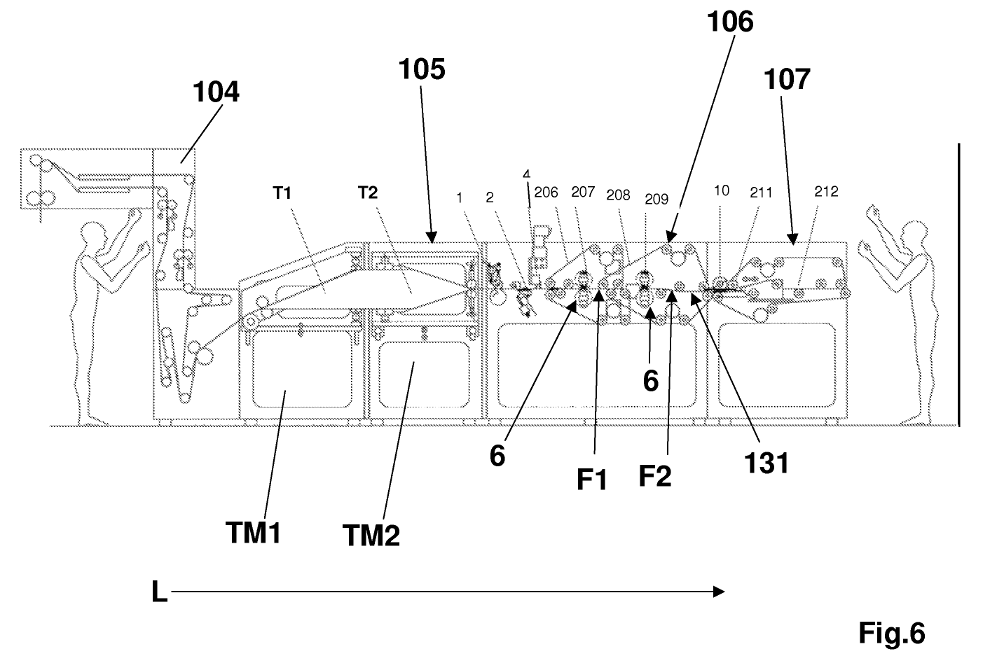

FIG. 5 and FIG. 6 show an example of a construction of a folder 103 which is arranged downstream of the printing units 102a, 102b or which can be arranged downstream of printing units 102a, 102b and which, according to FIGS. 5 and 6, includes a plurality of folding devices T1, T2 comprising formers arranged in series in the running direction L of the paper web 108. The folding devices T1, T2 are arranged in a former module TM1, TM2. However, as will be explained with reference to FIG. 16, the folding devices T1, T2 can also be omitted or at least circumvented within the meaning of the invention.

Folder 103 comprises a web turner device 104, for example, in the form of a turner bar device, a folding module 105 (this may also be omitted as, for example, in the construction according to FIG. 16), a cutting module 106, and a delivery module 107. In the example shown in FIGS. 5 and 6, the cutting module 106 and delivery module 107 contain the following components, although this is not compulsory: a first nipping section 1 (driven by an independent motor in the present example), a cutoff device 2, a second nipping section 3, a cutoff compensator camera 4, which is optional as the case may be, for visually monitoring the operation and functioning of the cutting device 6 and for supplying corresponding monitoring data to the control device 20, a small nipping section 5, a cutting device 6 with drive motor 28, a paper sheet transporting element 131 in the form of a conveyor belt, a swing-out device 7 for the paper sheet transporting element 131, a belt roller 8 which is adjustable (to product length and print format), a drive 9 for the belt conveyor 7, a device 10 for slowing down the transporting movement of paper sheets B1, B2, B3 . . . with a drive 11 and a clamping point for the belt roller which is adjustable (to product length or print format), a transfer device 211 for transferring the paper sheets to a belt conveyor of a paper sheet delivery so as to be adjustable to the respective format length of the paper sheets, and a belt retarder device 212 of the belt conveyor at the delivery.

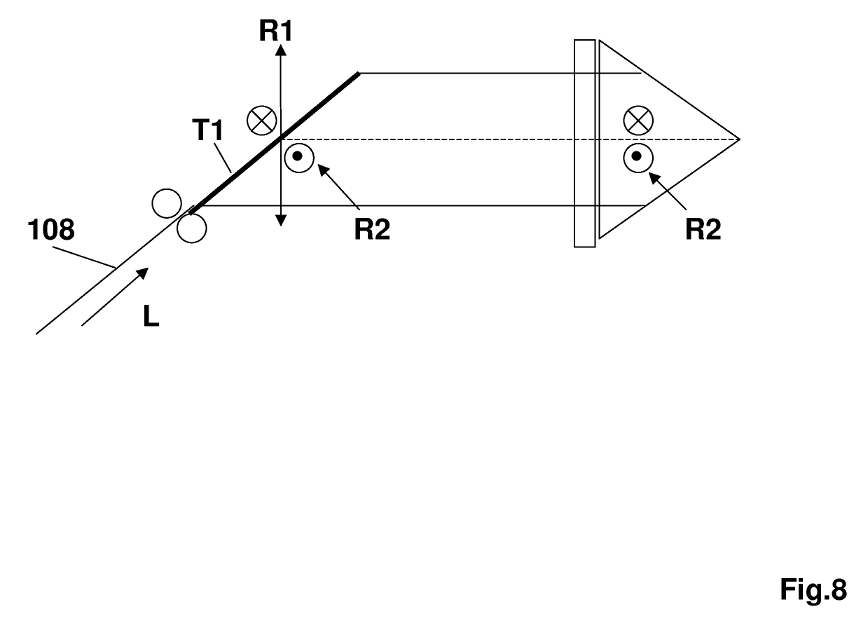

As is shown in FIG. 8, the folding module 105 is constructed such that every folding device T1, T2, i.e., every former, is displaceable in at least one spatial direction R1, R2. The first folding device T1, i.e., the first former is displaceable in a first spatial direction R1 parallel to the drawing plane (double-arrow), and the second folding device T2, i.e., the second former, is displaceable in a spatial direction R2 perpendicular to the drawing plane (tip of arrow indicated by a circle with a dot, end of arrow indicated by circle with a cross). This allows a greater freedom in aligning and adapting the folding devices T1, T2 to a wide variety of print formats and paper web widths or paper web guides without having to adapt (e.g., spatially displace) the components 1 to 12 of the post-processing equipment 103 arranged downstream in the running direction of the paper web 108 to modified print formats and paper web widths or paper web guides. Rather, this can be implemented by the displacement of the folding devices T1, T2. In so doing, a change in the width of the paper web 108, for example, can be compensated in such a way by a displacement of the first folding device T1, i.e., the first former, in the first spatial direction R1 parallel to the drawing plane that the center of the folded paper web 108 is again located exactly on the fold line (dashed line) which leads to the tip of the second folding device T2, i.e., the tip of the second former. Accordingly, in particular, it is unnecessary to adapt the relative position and setup of the paper sheet transporting element 131 in the form of a belt conveyor to changed print formats and paper web widths or paper web guides as is required in DE 40 30 863 A1.

As is shown in FIG. 8, the first folding device T1, i.e., the first former, is also additionally displaceable in the second spatial direction R2 perpendicular to the drawing plane (tip of arrow indicated by circle with dot, end of arrow indicated by circle with cross). Accordingly, for example, an asymmetrical, i.e., off-center, guiding of the paper web through the printing devices can also be compensated by the displaceability on two axes accompanied by a variability of the web widths and print formats without having to adapt (e.g., spatially displace) components 1 to 12 of the post-processing equipment 103a arranged downstream in the running direction of the paper web 108 to changed print formats and paper web widths or paper web guides. Accordingly, for example, instead of a full-width paper web 108, only a partial width of the web can be guided through the printing units 102a, 102b, i.e., such that it is not guided medially or symmetrically through the printing units 102a, 102b, but off-center or asymmetrically. The offset of the center of the paper web 108 relative to the center of the printing units 102a, 102b can then be compensated by displacing the first folding device T1, i.e., the first former in the second spatial direction R2 perpendicular to the drawing plane.

As has already been described, the folder 103 or the post-processing equipment 103a has a paper sheet transporting element 131 with a drive 9 comprising a motor. The drive 9 is controlled or regulated by the control device 20 or by a control device separate from the control device such that paper sheets B1, B2, B3, B4, B5, B6 severed from the paper web 108 by the cutting device 6 are accelerated away from the rest of the paper web 108 in the running direction L of the paper web 108. This is shown in FIG. 15 and can also be realized in principle in a folder according to FIGS. 1, 2, 6 and 7.

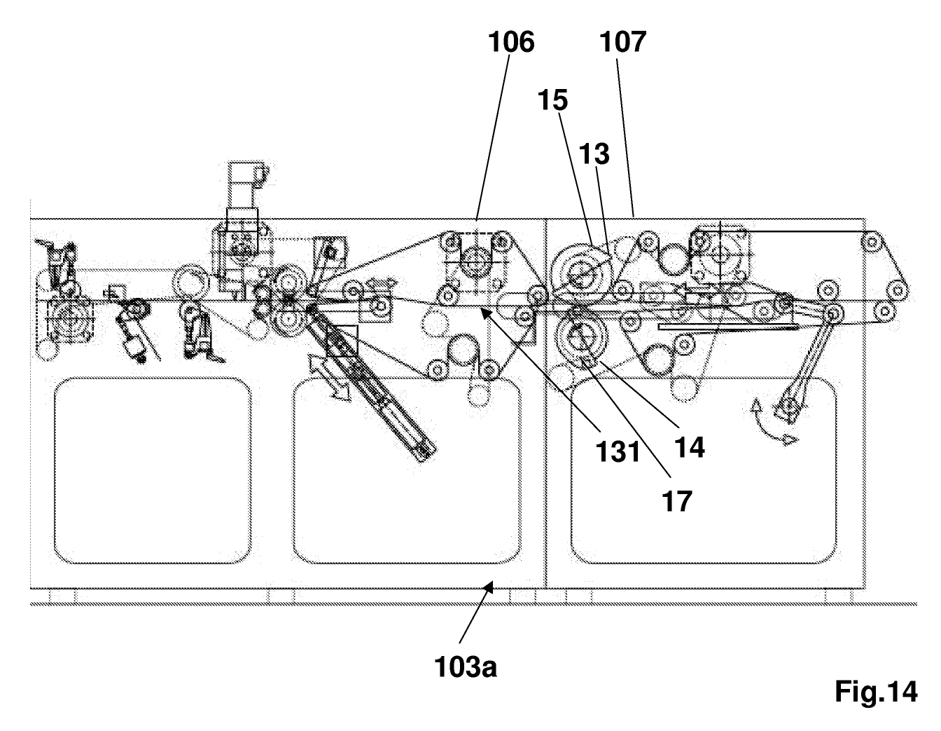

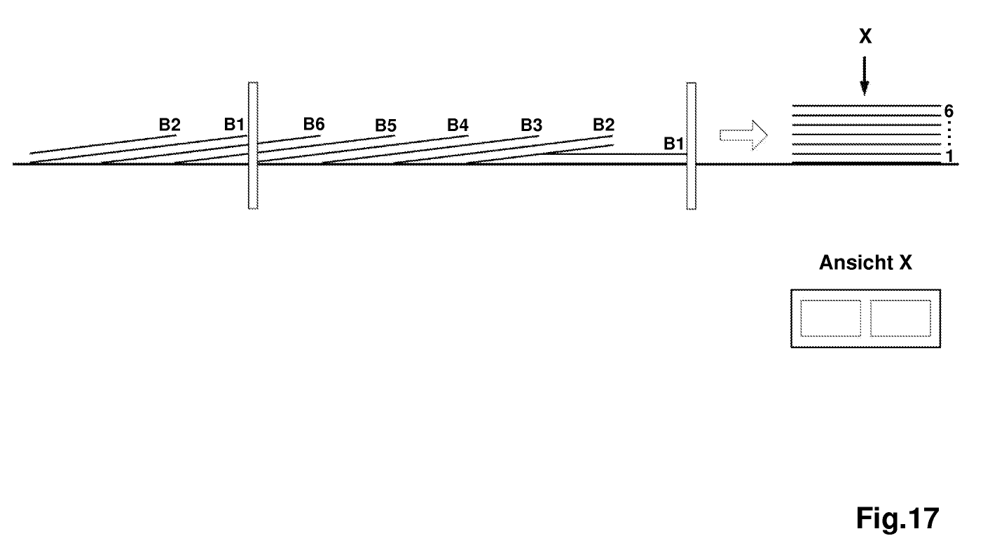

A device 10 with a drive 11, comprising a motor, is arranged downstream of the paper sheet transporting element 131. The drive 11 is also controlled or regulated by the control device 20 or by a separate control device, i.e., such that the transporting movement of the previously accelerated paper sheets B1, B2, B3, B4, B5, B6 is slowed down. The device 10 is constructed such that at least a portion of the paper sheets B1, B2, B3, B4, B5, B6, in addition to being slowed down, is lifted or lowered to achieve a shingling of the paper sheets B1, B2, B3, B4, B5, B6 as is shown in FIG. 17. This is performed according to FIG. 14 by a disk or roller 15 having in the circumferential direction at least one cam 13 that cooperates with a corresponding opposite cam 14 or a corresponding opposite disk or opposite roller 17. This also applies to a device according to FIGS. 1, 2, 6 and 7.

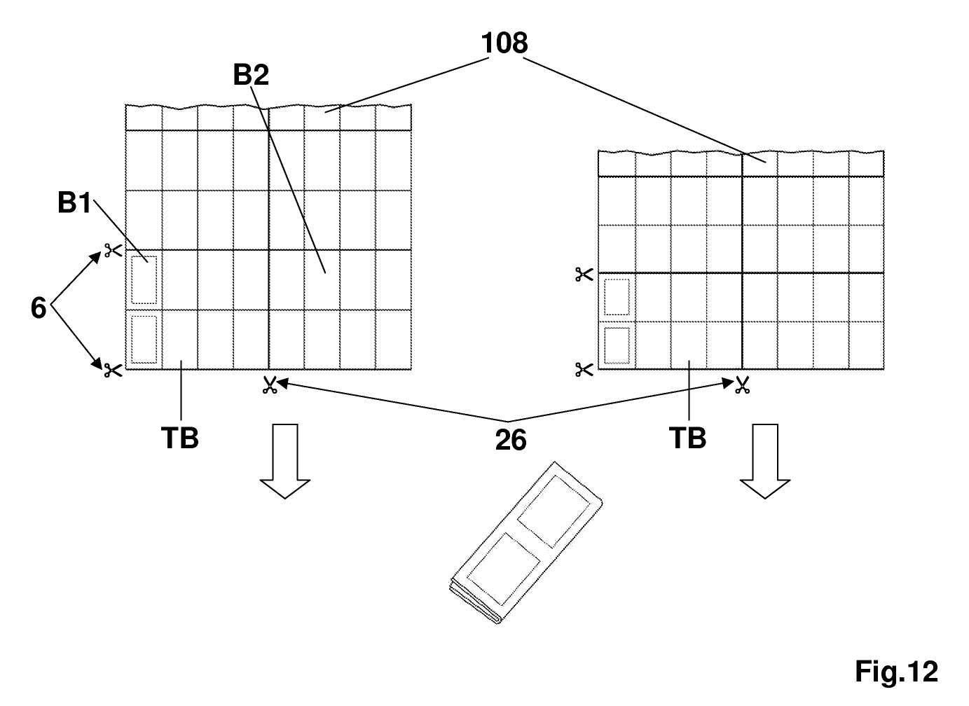

FIG. 17 shows how the individual paper sheets B1, B2, B3, B4, B5, B6 are pushed together to form a shingled stream. This shingled stream is subsequently consolidated in a collator downstream to form a stack of paper sheets 1 . . . 6 laid one on top of the other, for example, to form a book body and, if necessary, the lateral edges are then cut again to obtain a stack of individual sheets, for example, in the form of a conventional book, as a final printed product of a book printing production mode. View X is a top view of this stack. In the example shown in FIG. 17, every sheet has two printed sides. This corresponds to the results of a production mode according to FIG. 12.

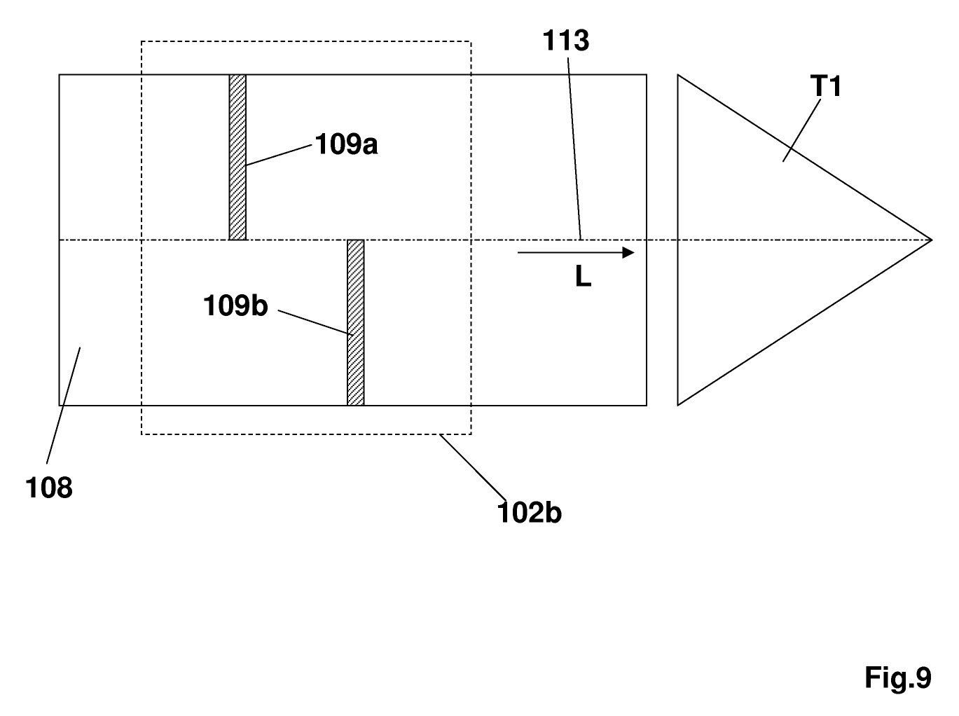

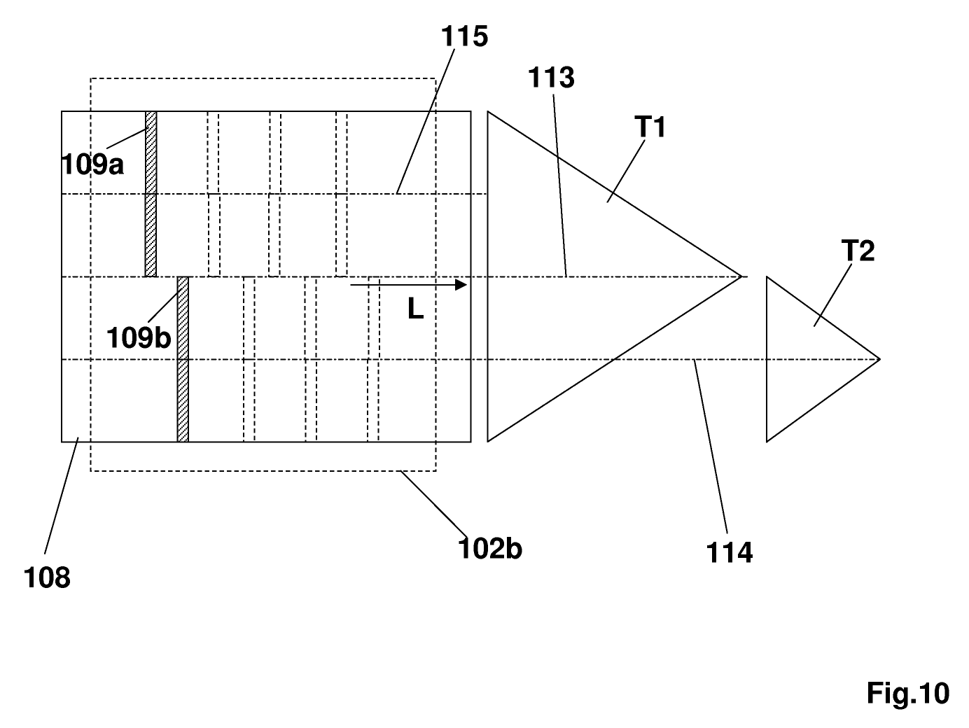

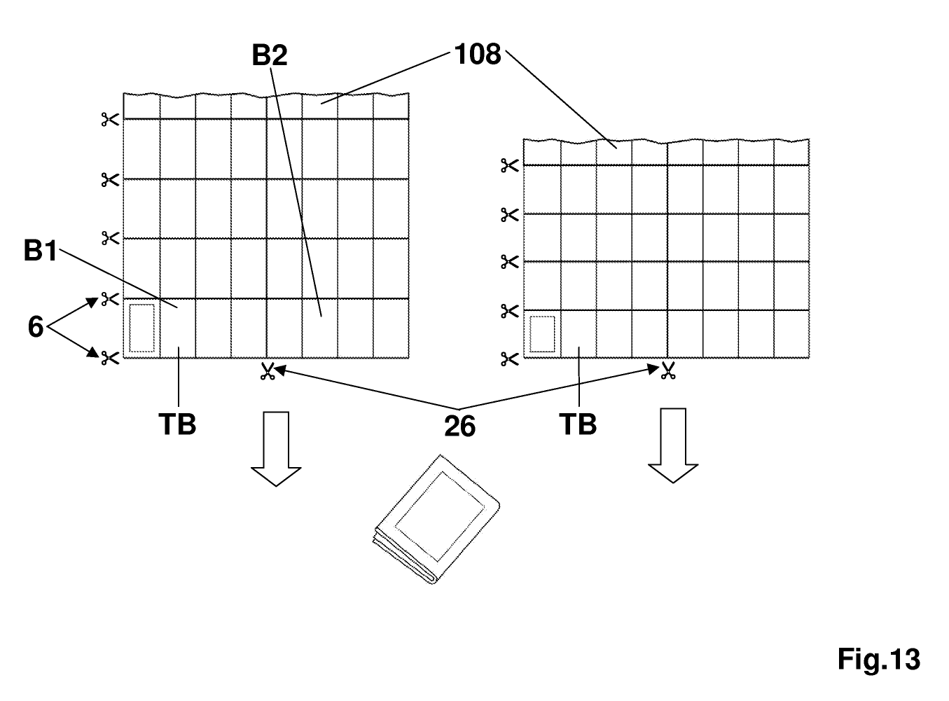

FIGS. 12 and 13 show production modes with the above-mentioned embodiments of the invention in which a (full-width) paper web 108 is cut by a longitudinal cutter 26 to divide the paper web 108 into web sections TB, and is then guided successively by two formers (indicated by triangles) as shown in FIGS. 9 and 10. Every web section TB is then subsequently cut by the cutting device 6 into paper sheets B1, B2.

As is shown in FIG. 16 in conjunction with FIGS. 14 and 15, the folder 103 need not necessarily have a folding module 105 with folding devices T1, T2. In a particular embodiment , the folding module 105 can also be omitted or can at least be circumvented. This can be performed in a device or production mode of the folder 103 shown in FIG. 16. For this purpose, only the following are required: a web turner device 104 which is arranged downstream of the printing units 102a, 102b and which has a plurality of longitudinal cutters 26 for dividing the paper web 108 into web sections TB, and post-processing equipment 103a according to FIGS. 14 and 15 which does not have a former and has a cutting module 106 for severing paper sheets B1, B2, B3, B4, B5, B6 from the rest of the paper web 108, and a delivery module 107 for gathering and/or delivering and/or shingling the paper sheets B1, B2, B3, B4, B5, B6.

Accordingly, the web sections TB generated in the web turner device 104 are not folded further but are merely cut again into paper sheets B1, B2, B3 by the cutting device 6, possibly after some or all of the web sections TB have been placed one on top of the other by corresponding devices such as turner bars in the web turner device 104. The paper sheets B1, B2, B3, B4, B5, B6 are then shingled again as is shown in FIG. 17.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-10. (canceled)

11. A device for cutting a paper web comprising a cutting module having a cutting device, wherein the cutting module includes a plurality of guide devices, each of the plural guide devices having at least one of a partially planar and movable guide area for guiding the paper web through the cutting module.

12. A device for cutting a print substrate comprising a cutting module having a cutting device, wherein the cutting module includes a plurality of guide devices, each of the plural guide devices having at least one of a partially planar and movable guide area for guiding the print substrate through the cutting module.

13. The device according to claim 11, wherein at least one of at least one guide device of said plural guide devices comprises a cutting element of the cutting device, the at least one guide device includes guide elements which are movable with the paper web and the cutting element for cutting the paper web is formed only in those sections of the paper web in which the at least one guide device has no contact with the paper web.

14. The device according to claim 12, wherein at least one of at least one guide device of said plural guide devices comprises a cutting element of the cutting device, the at least one guide device includes guide elements which are movable with a print substrate and the cutting element for cutting the print substrate is formed only in those sections of the print substrate in which the at least one guide device has no contact with the print substrate.

15. The device according to claim 12, wherein at least one of at least one guide device of said plural guide devices comprises a belt conveyor and a plurality of cutting elements arranged one behind the other are provided in a running direction of the print substrate and configured to cut the print substrate into sections of the print substrate, said sections being offset relative to one another transverse to the running direction of the print substrate.

16. The device according to claim 15, wherein the print substrate is a paper web.

17. A folder and a device for cutting a print substrate, wherein
the device for cutting the print substrate comprises a cutting module having a cutting device and a plurality of guide devices, each of the plural guide devices having at least one of a partially planar and movable guide area for guiding a print substrate through the cutting module; and
the folder comprises a plurality of folding devices arranged one of in series and in parallel with one another in a running direction of the print substrate.

18. The device according to claim 17, wherein the print substrate is a paper web.

19. The folder according to claim 17, wherein each of said plural folding devices is displaceable in at least one spatial direction, and wherein at least one of
a first folding device of said plural folding devices is displaceable in a first spatial direction and a second folding device of said plural folding devices is displaceable in a second spatial direction perpendicular thereto, and
at least one folding device of said plural folding devices is displaceable in said at least one spatial direction and is additionally displaceable in one of the second spatial direction and in a third spatial direction perpendicular to the first spatial direction.

20. A variable format printing press, comprising:
printing devices for printing a printing substrate;
a device for cutting a paper web comprising a cutting module having a cutting device, wherein the cutting module includes a plurality of guide devices, each of the plural guide devices having at least one of a partially planar and movable guide area for guiding the paper web through the cutting module; and
a control device for at least one of controlling and regulating at least one of printing devices and an actuating device of the cutting device for cutting at least a portion of the print substrate depending on print format settings for the printing devices.

21. The variable format printing press of claim 20, wherein the print substrate is a paper web and the variable format printing press is a web press.

22. The printing press according to claim 20, wherein the control device is configured to at least one of control and regulate a motorized actuating device of the cutting device with cutting elements.

23. The printing press according to claim 22, wherein the cutting elements are cutting knives.

24. The printing press according to claim 20, wherein the control device is configured to at least one of control and regulate the actuating device based on one of pre-stored and pre-calculated control curves.

25. The printing press according to claim 20, wherein the cutting device includes rotating cutting elements, and the control device for at least one of controlling and regulating the actuating device is configured such that the cutting device is operable at a varying angular velocity per revolution such that the angular velocity is equal to a transport speed of the print substrate when a cutting knife contacts the print substrate.

26. The printing press according to claim 25, wherein the print substrate is a paper web.
